(19) United States
(12) Patent Application Publication
(10) Pub. No.: US 2006/0149828 A1
(43) Pub. Date: Jul. 6, 2006

(54) Method and system for conducting client-to-server or peer-to-peer or mixed mode data synchronization

(76) Inventor: Dan Kikinis, Saratoga, CA (US)

Correspondence Address: CENTRAL COAST PATENT AGENCY, PO BOX 187, AROMAS, CA, 95004, US

(21) Appl. No.: 11/300,712

(22) Filed: Dec. 13, 2005

Related U.S. Application Data
(60) Provisional application No. 60/637,306, filed on Dec. 16, 2004.
(60) Provisional application No. 60/638,233, filed on Dec. 21, 2004.

(51) Int. Cl. G06F 15/16

(52) U.S. Cl. 709/217

(57) ABSTRACT

A system for synchronizing data between at least 2 separate appliances connected to a communications network includes one appliance of the at least 2 separate appliances for initiating synchronization, a data record containing editable and non-editable fields, and a software program for separating individual ones of editable fields and non-editable fields from the record and packaging them for transmission over the network to one or more of the other appliances.

### CROSS-REFERENCE TO RELATED APPLICATIONS

The instant case claims priority to provisional patent application Ser. No. 60/637,306 filed on Dec. 16, 2004. The instant case also claims priority to provisional patent application Ser. No. 60/638,233 filed on Dec. 21, 2004.

### BACKGROUND OF THE INVENTION

1. Field of the Invention

The present invention is in the field of data synchronization of electronic documents over a digital network and pertains particularly to methods for enhancing data synchronization using fewer resources and steps.

2. Discussion of the State of the Art

In the field of data synchronization several common synchronization schemes have been developed for synchronization of data between two or more nodes having connection to a data network. Common data synchronization environments include those that involve data synchronization between handheld personal computing devices and main computing devices or servers. Servers, personal computers (PCs), and the like often are adapted in a personal computing sphere (PCS) to sync data between themselves. A common scheme is a Personal Information Manager-type scheme common in the art.

Devices that can synchronize data using known schemes include a wide range of commuting devices or embedded devices with computing capabilities. These device types may include phones, personal digital assistants (PDAs), home control units (HCUs), car systems, digital car stereos, hand-held digital music payers, and so on.

IntelliSync™, formerly PumaTech™ is one of the more commonly known company that offers products that provide network-based data synchronization. Other companies include Microsoft™'s Active Synch™. In addition there are some approaches that use synchronization markup language SynchML for offering an open industry standard for data synchronization. Another popular technology based on Intellisync™ is Blackberry™ by RIM™. There are several other companies emerging to partake in the data synchronization market.

All of the above-mentioned schemes have major generic drawbacks. The major limitation of the current state of art is that the data synchronization products are all server-centric and require a server such as Microsoft's Exchange Server™ in order to facilitate full data synchronization into an existing mailbox for example, on a client PC.

Another major limitation to current state-of-art systems is that they do not conserve network bandwidth sufficiently, nor do they properly account for network latency. One reason for this is that these systems have evolved as a wireless simulation of connected synchronization schemes. To illustrate this, one needs to think of a wireless version of a typical cradle- or cable-based synchronization protocol. These systems are not optimized to conserve bandwidth or in any way to streamline protocol such as the number of handshakes required between two nodes before synchronization can begin. In a slow, wired connection multiple handshakes may be acceptable however, in a high latency wireless network frequent handshakes as a prerequisite to successful data transfer may create unusable delays when synchronizing a full data set. The just mentioned limitation is particularly apparent when a full-featured mailbox system such as a Microsoft Outlook™ client, which has multiple sources for mail feed and other activities, is involved.

Therefore, what is clearly needed is a system for data synchronization that does not require the presence of a server and facilitates peer-to-peer data synchronization in a manner that conserves bandwidth, streamlines protocol, and greatly reduces latency problems in fast wireless networks.

### SUMMARY OF THE INVENTION

A system for synchronizing data between at least 2 separate appliances connected to a communications network is provided. The system includes one appliance of the at least 2 separate appliances for initiating synchronization, a data record containing editable and non-editable fields, and a software program for separating individual ones of editable fields and non-editable fields from the record and packaging them for transmission over the network to one or more of the other appliances.

In one example, the communications network is the Internet network including one or more sub networks connected to the Internet network. In this example, the communicating appliances are of the same type or any mix of, desktop computers, laptop computers, cellular telephones, personal digital assistants, digital music players, hand held communicators, desktop entertainment systems, mobile information systems, and data servers. Also in this example, the appliance initiating a synchronization is one of a desktop computer, a laptop computer, a cellular telephone, a personal digital assistant, a digital music player, a hand held communicator, a desktop entertainment system, or a mobile information system.

In one case, the non-editable fields include one or more fields for identifying the record, a source appliance that originated the record and the source appliance that initiated a revision to the record. In one case, the editable fields include one or more fields adapted to contain data about an item, pointers to attached data, or command lines for performing one or more tasks related to an item.

In a preferred example, the data record provides at minimum identification data related to the record identification, field identification, source device identification, item revision identification, and status related to a change implementation. In one example, the data record further identifies the source machine making a data change, the name of the user making the data change, and the name of the user who originally created the record.

In one example, the software program is an application program interface installed to an appliance-resident data processing program. In this example the data processing program may be one of a word processor, a calendar application, a scheduler, a drawing program, a picture editing application and an email client or a personal data organizer.

In a variation to the above example, the software program may be automatically invoked and automatically completes field replication, packaging, and buffering for transmission based on the user working in a resident client application for editing an item.

According to another example of the present invention, a data record for facilitating data synchronization is provided. The data record includes a plurality of editable and non-editable data fields, a unique identifier associated with one of the non-editable fields identifying the source of the data record, and a unique identifier associated with one of the non-editable fields identifying one or more sources who have edited the data record.

In one example, the data record further includes an identification of a user that created the record, and identification of any users who have edited the record.

According to yet another example of the present invention, a transmittable synchronization package for synchronizing data between at least two appliances connected to a communication network is provided. The synchronization package includes at least one editable data field containing data for synchronization or a pointer to data for synchronization, at least one non-editable data field for identifying a record, a source of the synchronization package, and a revision number for the changed data.

According to still another example of the present invention, a software application for facilitating data synchronization between at least 2 appliances connected to a communications network is provided. The software includes a portion thereof for representing an item in the form of a record, the record containing editable and non-editable fields, a portion thereof for separating individual ones of the editable and non-editable fields from the record into a transmittable update package and for transmitting the package over the network, and a portion thereof for receiving the transmitted package and applying that package to a version of the original record.

In one example, the software application further includes a first application program interface installed to a generic software application adapted to edit the item, the interface adapted to automatically create the transmittable package, and a second application program interface installed to the generic software application adapted to edit the item, the interface adapted to automatically apply the changed data to the item and to the resident copy of the changed record.

In the above example, the generic application may be one of a word processor, a sound editing application, a graphics editing application, a drawing program, a Web page editing application, or a movie editing application.

According to a further example of the present invention, a method for synchronizing data between two or more appliances connected to a communications network is provided. The method includes different cases (or acts, or activity scenarios) for (a) editing an item or performing a task related to an item on a sending appliance, (b) updating a local record of the item and retaining the change data from the record, (c) packaging the change data and the record and source identification data for transmission as a record update, (d) transmitting the package to the other appliance or appliances designated to receive synchronization, (e) receiving the package at the other appliance or appliances, (f) updating the local copy of the original record on that appliance or appliances according to the package contents, and (g) applying the change data from the new record to the item or items to be changed.

In one aspect of the method, in act (e) a receipt is generated and sent back to the sender after validating the package. In another aspect of the method, acts (b) and (c) are automatically performed by an application program interface installed to editing or tasking software adapted to edit or perform tasks related to the item. In this aspect, acts (e) through (g) may also be automatically performed by an application program interface installed to editing or tasking software adapted to edit or perform tasks related to the item, the application program interface invoked at act (e) after the package is sufficiently identified. In still another aspect, in act (d), the transmission is metered to avoid taxing bandwidth reserved for a higher priority task simultaneously being performed by a sending appliance.

### BRIEF DESCRIPTION OF THE DRAWING FIGURES

FIG. 1 is an architectural overview of a communications network practicing data synchronization according to an embodiment of the present invention.

FIG. 2 is a plan view of an exemplary record containing separately detachable fields according to an embodiment of the present invention.

FIG. 3 is a process flow chart illustrating acts for initiating and preparing a data or record update for synchronization according to an embodiment of the present invention.

FIG. 4 is a process flow chart illustrating acts for transmitting an update for synchronization according to an embodiment of the present invention.

FIG. 5 is a process flow chart illustrating acts for receiving an update for synchronization according to an embodiment of the present invention.

### DETAILED DESCRIPTION

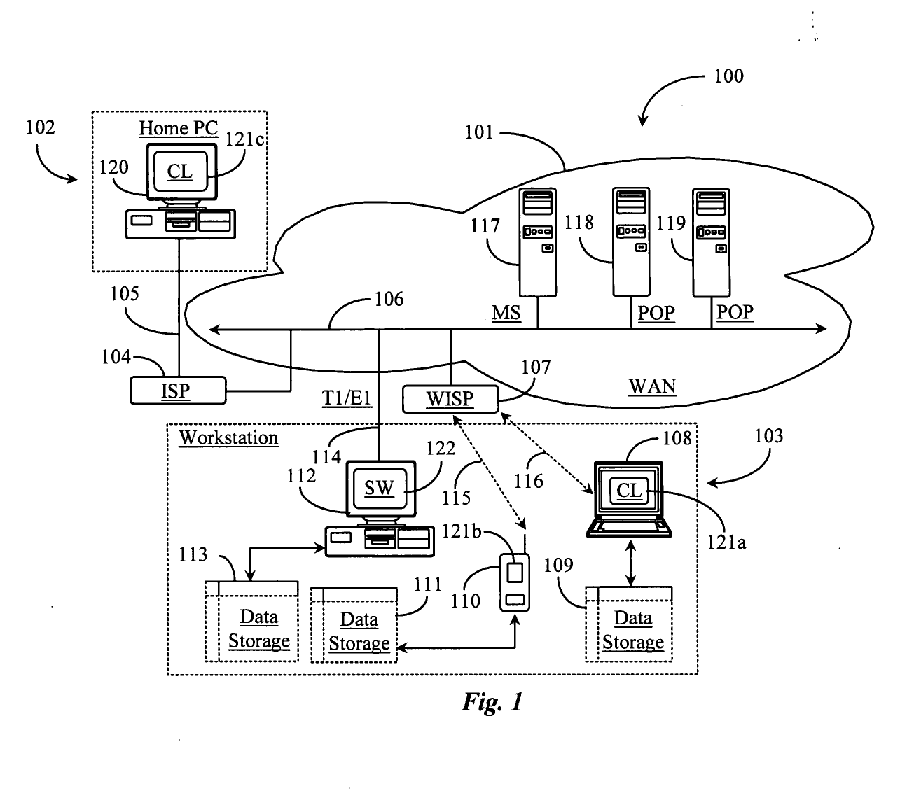

FIG. 1 is an architectural overview of a communications network 100 practicing data synchronization according to an embodiment of the present invention. Communication network 100 may be thought of as a personal computing sphere (PCS) network that is inclusive of various devices and nodes that may engage in data synchronization.

A wide-area-network (WAN) 101 is illustrated in this example and provides an example of a medium over which data may be exchanged. However, it will be clear to one with skill in the art that there are a variety of wire line and wireless networks and combinations thereof that will support data synchronization between two or more appliances without departing from the spirit and scope of the present invention. WAN 101 may be the Internet network in one example. In other examples WAN 101 may be a corporate network or any combination of local wide and sub networks connected to the Internet network. The only requirement for WAN 101 is that is supports transmission control protocol over Internet protocol (commonly referred to as TCP/IP suite with possible extensions and enhancements) and or any other transmission protocols used over digital networks to propagate data between nodes by them selves or in any suitable combination.

WAN 101 has a network backbone 106 extending there through that represents all of the lines equipment and access points for the network as a whole. Therefore, in an example of an Internet 101 there are no geographic limitations to the practice of the present invention. A Microsoft exchange server (MS) 117 is illustrated within WAN 101 and connected to backbone 106 for communication. A post office protocol (POP) server 118 and a POP server 119 are similarly illustrated within WAN 101 and are connected to backbone 106 for communication. It is clear, that other, suitable mail protocols may be used instead or in combination.

MS 117 is adapted as a collaboration and communication-hosting server for corporate collaboration on projects. POP servers 118 and 119 are mail servers adapted to collect and store emails for clients. Servers 118, 119, and exchange server 117 are well known in the art and are typically included in many instances of data synchronization where a server-based system is employed. However, one object of the present invention is to provide a system that does not require a robust or permanently available (to the appliance) server application.

A workstation 103 is illustrated as part of communications environment 100. Workstation 103 may be a corporate workstation such as part of an enterprise communication center, perhaps manned by a knowledge worker in one example. Workstation 103 contains various communication systems or devices that may be used in collaboration. A main PC 112 is provided within workstation 103 and is adapted as a main or central computing system. PC 112 has associated therewith a data storage system 113 adapted to store data. Storage facility 113 may be an internal drive or it may be an external data storage facility connected to PC 112 via local network cable, universal serial bus (USB) cable, serial cable, or some wireless protocol. Generally speaking, facility 113 is used for the purpose of storing documents and the like produced using PC 112 or documents that are editable using a resident program installed on PC 112. Moreover, email, media, electronic calendars, and other data may also be stored on and available from facility 113.

PC 112 has a WAN connection T1 or E1 digital cable 114 to WAN 101 or more specifically, to backbone 106. In some cases, PC 112 may connect to WAN 101 through an Internet service provider (ISP) if WAN 101 is the Internet network or a sub network connected to the Internet. PC 112, in this example, is assumed to be the main work computer used as a central synchronization point for other associated computing appliances. PC 112 has a software application (SW) provided thereto and executable there from. SW 122 provides the data synchronization capabilities between PC 122 and other related appliances that are closely associated to PC 112 such as belonging to a single owner and authorized user of SW 122.

Workstation 103 includes other computing appliances such as a smart telephone (SP) 110 and a laptop computer 108. SP 110 is, in this case, a digital phone adapted to access WAN 101 the network wirelessly through a wireless Internet service provider (WISP) 107 via a wireless network link 115. SP 110 has a data storage facility 111 associated therewith. Data storage facility 111 is likely internal to SP 110 however, the inventor illustrates facility 111 separately for discussion purposes only.

Laptop computer 108 has a data storage facility 109 associated therewith, which may be an internal disk drive or some external data storage facility accessible to laptop 108 via a wire line or wireless network link, USB, or serial cable. Data storage facilities 111 and 109, like facility 113 are adapted to retain data in the form of documents, calendar data, as well as other types of media including audio and graphics. It is important to note herein that each appliance namely laptop 108 and SP 110 may also have a communication link to PC 112 in some examples and therefore may be defined as peripherals. Moreover, SP 110 may instead be a personal digital assistant (PDA) or some other handheld computing device such as a PalmOne Treo™, an Apple Ipod™, an MP3 player, or some other device that may be connected to PC 112 and that has a storage facility associated therewith.

Laptop 108 has a client software (CL) 121a provided thereto and executable there from. CL 121a is adapted as a client to SW 122 and as an independent application for synchronizing with other computing appliances other than PC 112 in a peer-to-peer fashion. CL 121a is not specifically required for laptop 108 to perform a data synchronization with PC 112 using its regular mail software (not shown), but enables peer-to-peer synchronization of individual fields of an electronic record that would represent a whole electronic document or electronic presentation of data in any form. SP 110 has a CL 121b provided thereto and adapted for the same purposes described with respect to CL 121a except that it is also provided specifically in a version compatible to and useable on SP 110.

It is clear to one with skill in the art that there may be more types of computing appliances having data storage and network capabilities included in a personal computing sphere (PCS) data synchronization group than are illustrated in this example without departing from the spirit and scope of the present invention. It is also clear that laptop 108 and SP 110 do not necessarily have to reside within workstation 103 or in any close proximity to PC 112 in order to practice the present invention. Other types of network-capable appliances may include PDAs, automobile information and mapping systems, in home digital entertainment systems having network access, and so on.

A home domain 102 is illustrated in this example, and represents a home location that may be far removed from workstation 103. A home PC 120 is illustrated within home domain 102. Home PC 120 has access to WAN 101 through an Internet service provider (ISP) 104 via an Internet access line 105. It may be assumed in this example that the authorized user of workstation 103 is the same authorized user of home PC 120. Home PC 120 has a CL instance 121c provided thereto and adapted as client software to SW 122 and as an independent application for synchronizing data with other appliances without having to establish a connection with PC 112.

In a preferred example, appliances 108, 110, and 120 may initiate and synchronize data with each other and with PC 112. Likewise, PC 112 may synchronize data with MS 117 and then with any other authorized appliance without requiring repeat access to MS 117 by other appliances. Depending on the appliances used to send and receive synchronization data, the transmission protocols may include but are not limited to wireless application protocol (WAP) embedded protocol as used with a WAP gateway, transmission control protocol (TCP) or UDP or a similar over Internet protocol (IP), or to a proxy server as mentioned above. Such disparate protocols may include any type of suitable protocol, such as, but not limited to, transfer control protocol (TCP/IP), user datagram protocol (UDP), hypertext transfer protocol (HTTP), and secure HTTP (HTTPS), wrapped multi-protocol systems, WAP, handheld device markup language (HDML), extensible hypertext markup language (XHTML), and dynamic HTML (DHTML) by themselves or in any combination, eXtensible Markup Language (XML) or any other similar suitable protocol.

SW 122 may also be provided in a version compatible with a robust server such as MS 117 or any other networked server responsible for maintaining updated versions of electronic documents, forms, or other types of presentable data. For example, an electronic inbox containing dated messages may be considered a presentable data set for synchronization. In one example, PC 112 may go online and synchronize an inbox with one maintained on MS 117. Then PC 112 may synchronize that inbox with one or more other appliances like laptop 108, SP 110, and/or home PC 120 using CL applications installed.

In one example of the present invention, each appliance authorized to synchronize data may just have a resident software similar to CL 121a-c without requiring a main SW instance installed on any one computer. If PC 120, for example, connects with MS 117 to access email, CL 121c may be activated to automatically replicate the current state of the inbox on the mail client of PC 120 to PC 112, laptop 108 and/or SP 110. All that is required is that a data connection be established between the sending and receiving device for the time it takes to synchronize the data. Moreover, one of the peer appliances may request a change such as deleting certain emails from the updated inbox. These tasks may now be automatically synchronized back to PC 120, which may then synchronize back to MS 117. In the time required for this process, MS may yet have new data for download and/or synchronization. The apparatus of the present invention may be used as solely a peer-to-peer synchronization system or it may be used in a sever-centric environment in combination with peer-to-peer capabilities.

The software of the present invention exemplified herein by SW 122 and CLs 121a-c enables a typical record of data to be broken down into separate and editable fields that may be packaged for transmission over the prevailing network or link as a portion of a whole record. Therefore, an item may be updated to a latest version without creating an entire record or transmitting any data that already exists. For example, a calendar form may have several appointments or “items” embedded therein which display as current calendar schedule information when viewed on any computerized display. Each item then has a record that includes several fields. Each field of the record provides the complete data for that field. To change a calendar item using the method of the present invention, a user from any authorized appliance may edit any of the editable fields of the record of the item and then may transmit only the edited field along with one or more required fields that provide identity and revision tracking so that a recipient of any updated field can be sure it is the latest revision of the record.

The process of the invention does not require the whole item to be replaced in the calendar. Field granularity (atomicity of data) may be as detailed as having a separate field for begin time of a calendar event and another field for end time of the event, while still another field may be provided for the date of the event and so on. One with skill in the art will recognize that different forms of media will have somewhat differing record fields, and therefore a different level of atomicity may be suitable. The novel capability of the system is exemplified in that the initiator of a change of an “item” may simply edit a field and then transmit only that field and the field or fields required to identify the record and revision source on the receiving end. Revision tracking according to examples of the present invention may include keeping multiple fields of a particular data each field identifying a source ID and revision number for the data that is in that field. In this way any user may track back to earlier versions of an item that has been revised and may identify the source device, user, and date and revision that particular field was made. In summary, ideally only the minimal atomicity level of changes is transmitted.

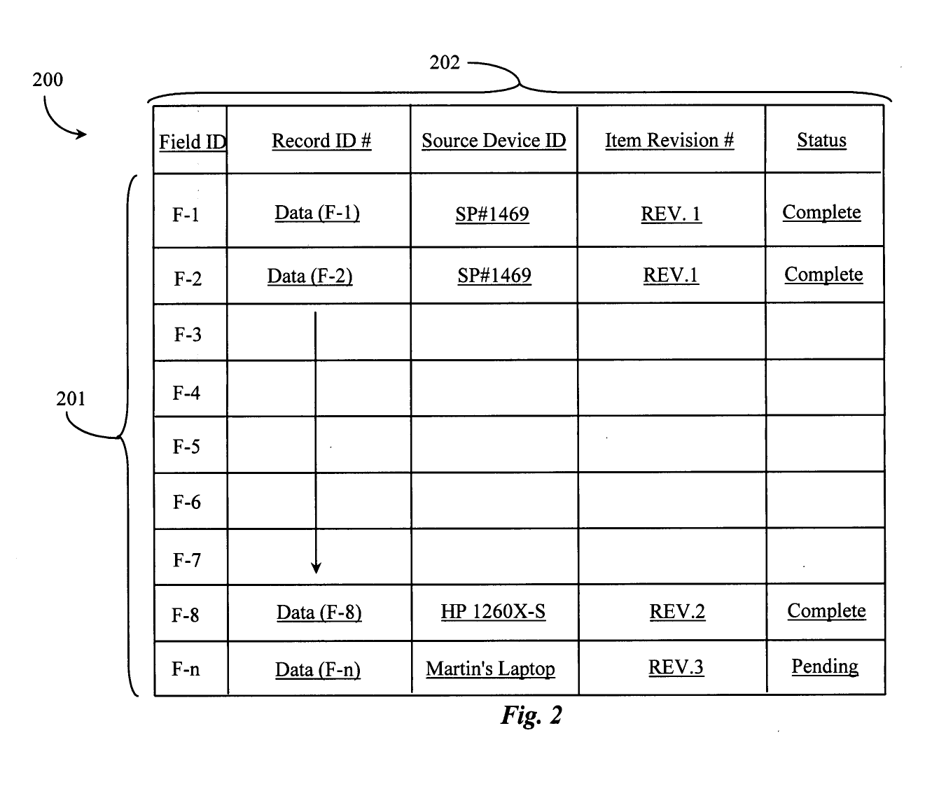

FIG. 2 is a plan view of an exemplary item record 200 containing separately detachable fields according to an embodiment of the present invention. Item record 200 is formatted for visual aid into a plurality of columns 202 and rows 201. Each column 202 has a heading, reading from left to right, including a field identification ID number, a record ID number, a source device ID #, an item revision number, and a status indicator.

Rows 201 represent separate data fields which together make up all of the data of an item. Reading from top to bottom in the field ID column, item record 200 contains fields F-1 through F-n. Each field F-1 through F-n includes data for that field represented in this example as data (F-1), data (F-2), through data (F-n). The data fields include the record ID so that when data fields are sent separately, they may be associated at the receiving end with the correct item record hence the correct item. In some examples some of the data fields may not be editable fields while others of those fields may be editable. Such considerations may depend on the type of media the item belongs to.

For example a progressively encoded JPEG picture may be divided into such fields, containing time, date, recording method, compression method, layers of progressive encoding, and the like. A small edit may be incorporated by only sending the changed fields in this example, the section of layers edited.

Each data field F-1 through F-n includes a source device ID number that identifies the source device that created the field or that edited the field. For example, record 200 reflects that F-1 has been created or edited by SP# 1469. By expanding SP# 1469, a user may retrieve the date and time that the field was created or updated. F-2 was also created or edited using SP # 1469. F-8 was created or edited by Hewlett Packard (HP) 1260X-S, which may be analogous to home PC 120, or main PC 112 of FIG. 1 above. F-n was created or edited by Martin's laptop, which may be analogous to laptop 108 of FIG. 1. It is important to note herein that computing appliances authorized to edit data fields may be identified in a number of ways and the above names used represent exemplary naming conventions only. Names may be created for each device that may be associated with a user or a user's group. IP addressing, machine addressing, serial number, or other naming schemes may be used as long as each device may be uniquely identified in the PCS. In some examples, computing appliances may log on to a web page and register as authorized devices using temporary identification numbers.

F-1 and F-2 each indicate that the data of the field is revision 1 indicating that SP #1469 first revised record 200. F-8 is a second revision (REV .2) and F-n is a third revision (REV .3). In this example, the status of F-1 through F-8 of record 200 is complete meaning that all of those data fields of the record are currently up to date. F-n indicates in the status column that the transmission of REV. 3 has begun and is still pending.

It is important to note herein that one or more security regimens might be employed in a PCS synchronization system in order to insure that participating devices are properly authorized to edit, which may depend in part on the number of users having access to that device. For example, one of 4 persons having access to a computer adapted for practicing the present invention may be authorized by login procedure while the other computer users may not be authorized. Any mix is possible including separate authorization of all users having access to the computer and its programs.

In some examples, end-point devices that are not considered computing devices that can manipulate data may practice the method of the present invention. For example, one appliance may be an alarm clock with a network peripheral link to a main computer. The clock may receive only calendar data of the person or persons using the room or bedroom in which it is located, and may, based on rules, calculate the proper wake-up time and self-program accordingly. In some instances it may request permission on a case-by-case basis. In others it may work completely autonomously. It may also request information regarding weather and traffic, to calculate time for a 9 a.m. appointment at a certain location, etc. In the former case, the clock would not be an authorized device for making any changes however, such edits may be made from any of the authorized computing devices by requesting the pertinent calendar item record for edit. The updated record will be accessed or pushed to the alarm clock at the next available opportunity and may also be synchronized with any other devices in the PCS.

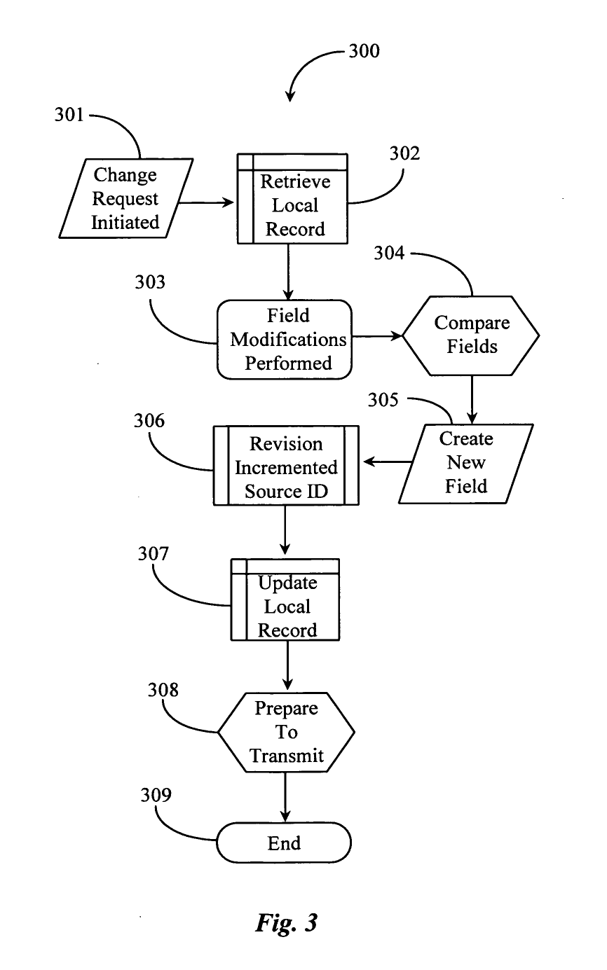

FIG. 3 is a process flow chart 300 illustrating acts for initiating and preparing a data or record update for synchronization according to an embodiment of the present invention. At act 301, a change request is initiated. A change request is simply a user from an authorized device changing something about a record. If a record is that of a word document, the main data field will contain all of the relevant text of that document. The editing user may, by calling up the document, also receive the associated record in some cases. As the user make edits in the document the software takes the change data and applies it to the appropriate data field, for example. The user may also add data directly to the record, in some instances, which may be used to append an earlier version of the document stored at another location. The program used to created and edit the document may, in some cases have an application program interface (API) installed and adapted to receive and parse the record when complete and therefore may copy only the changed data to the appropriate location in the text document. In this way much text overwriting can be avoided.

In act 301, the change request is initiated at the computing device that will change a record. The actual change will eventually be transmitted in the form of a “reclet”, or mini record. A reclet, for the purpose of this specification is one or more edited fields of a record or copy thereof that may be packaged and transmitted separately from the record or a copy thereof and that may be associated with the appropriate record version at the receiving end.

At act 302, the system or application requesting the change retrieves the record copy that is maintained in local storage, typically on the device used to make the change. At act 303, the authorized user using the authorized PCS device performs field modifications. Modifications other than actual data edits may be performed. For example follow-up receipts for emails may comprise a field change that does not necessarily require a user to edit data but still results in a modification of a field of a record. At act 304, the system compares the fields and identifies which field or fields are being edited.

At act 305, the software creates one or more new fields for updating the record. In addition to creating the field, the revision number from the previous version is incremented to reflect the new field and the source device or appliance ID is included to identify the user that created the field, the device that was used to create the field, and the time and date the change occurred.

At act 307, the software of the present invention updates the local record with the new information so that the first complete and most recent record is stored on the device that initiated the revision. At act 308, the system prepares to transmit the “reclet” for application to one or more remote record copies that also need updating. In some cases, a field may only contain a pointer to an attachment like an email with an attached document. The actual revision may be in the attachment rather than in the field. Therefore, the changed field may simply contain a pointer to a new attachment that contains a data change. In one case it could be a redlined attachment that contains changes within it. It is noted herein that in act 306, the master source ID indicating the original owner of a record is never changed. Therefore, any user may determine the source machine and user that originally created the item of which the record exists.

At act 308, the system prepares to transmit the reclet to one or more identified recipient nodes or appliances. Preparation includes packaging the reclet for transmission according to any applicable protocols used on the receiving appliance. In some cases more than on version of the reclet for transmission is prepared if the receiving appliances are different from one another in terms of operating system, display protocols, application version, or other like considerations. At act 309, the process on the sending device ends. It is important to note herein that a record may be modified by proxy by simply modifying a document or some other editable media type.

In one example, a user may edit a series of pictures by invoking a picture software application and the “picture album” containing the set of pictures and deleting a picture from the series. An API installed in the picture software may retrieve and modify the local record of the “picture Album” locally and the reclet prepared for transmission contains a data field that indicates what picture is deleted. Each picture may have its own data field so that a blank data field may indicate the required action to delete the picture from the album at all of the receiving appliances that contain the album with the picture to be deleted. A record may be that of a mail inbox, a calendar, an email, a document, a set of pictures, a set of documents, or any other manageable set of data.

In another example, there may be tasking fields included in a record such as “delete”, “forward”, “archive”, “add”, and so on. In this example, the record may be that of an email inbox duplicated on more than one appliance. The whole record would have data fields that point to each item or email in the record. As well, each “item” in the inbox may also have a record associated therewith containing all of the fields that make up the item. Further a record may also represent any attachments associated with emails. Subsequent records may be available through a main record in any data structure that may be represented in hierarchical fashion such as may be the case with a inbox, items within the inbox, and any attachments associated to those items.

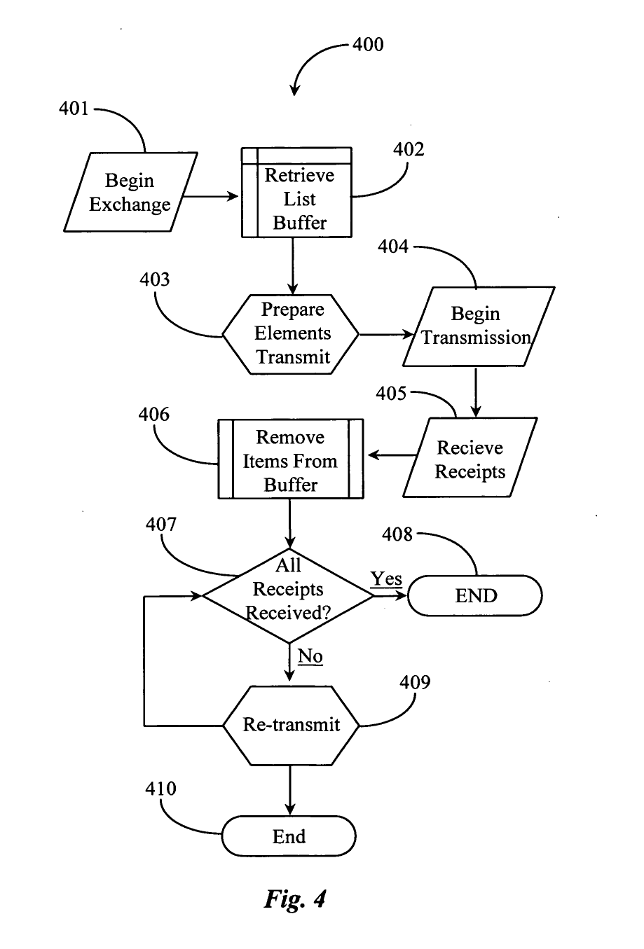

FIG. 4 is a process flow chart 400 illustrating acts for transmitting an update for synchronization according to an embodiment of the present invention. Process 400 may be a continuation of process 300 with act 401 the next logical act where transmission of a reclet begins. In this act, all that is required is that the sending appliance forge a data connection with a receiving appliance or with a proxy server adapted to host a connection between the sending appliance and one or more receiving appliances. Continuing from the process of FIG. 3, the act of beginning transmission may be automated, the connections formed automatically without interference from the user.

At act 402 the software retrieves a list of one or more packaged reclets from a buffer they were deposited in for transmission. At act 403, the software prepares the elements for transmission. In this act, the software insures that the proper protocols are applied according to the formats required by the receiving appliances. In some cases one or more reclets may be duplicated for transmission to more than one system wherein those system have differing protocols. For example if the sending device is a smart phone and the receiving device is a laptop computer then the appropriate protocols, gateway negotiations, and IP regimens if required are applied. In other cases such as for computer-to-computer transmission over the Internet no preparation is required as long as both systems are using the same operating platform and mitigating software applications.

At act 404 the sending appliance begins transmitting once the communication channel has been established. It is important to note herein that in peer-to-peer connections, the transmission and receipt of the reclet or reclets is a live transaction and in act 405, the sending appliance receives receipts from each destination appliance that it transmits to. A receipt is automatically generated at the receiving appliance and sent back over the same peer-to-peer or, in some cases, a proxy connection. In one example, transmitting the reclets may occur using a metered bandwidth to avoid taxing bandwidth reserved for a higher priority task such as an unrelated communication task simultaneously being performed by a sending appliance.

At act 406 the sending appliance may remove any items from the buffer for which it has received a receipt. At act 407 the software determines if receipts for all of the items in the buffer for transmit have been received. If all of the receipts have been received, then at act 408 the process ends. However, if not all of the receipts have been received the software identifies those reclets for which a receipt has not arrived within a certain pre-determined period of time and attempts to re-transmit the items at act 409. In some case a connection may go down. In this case, the software may retry the connection for a number of times before rescheduling the update. It is important to note herein that in the case of multiple reclets for transmission, all of the reclets are transmitted in a pipeline manner whereby the software does not wait for a receipt before transmitting a next reclet and so on.

In one case, the software of the present invention may attempt to propagate an update via some other route such as to a first node or intermediary to which a reliable connection may be established. The reclet may contain instructions for the intermediary node to update the original destination node that was the party to the unreliable connection. Peer-to-peer synchronization enables a much faster propagation of a synchronization task where many appliances are subject to the synchronization. In the case of a proxy agent the software treats the proxy agent as the end destination and expects to receive a receipt from the proxy before a reclet may be cleared from the transmission buffer.

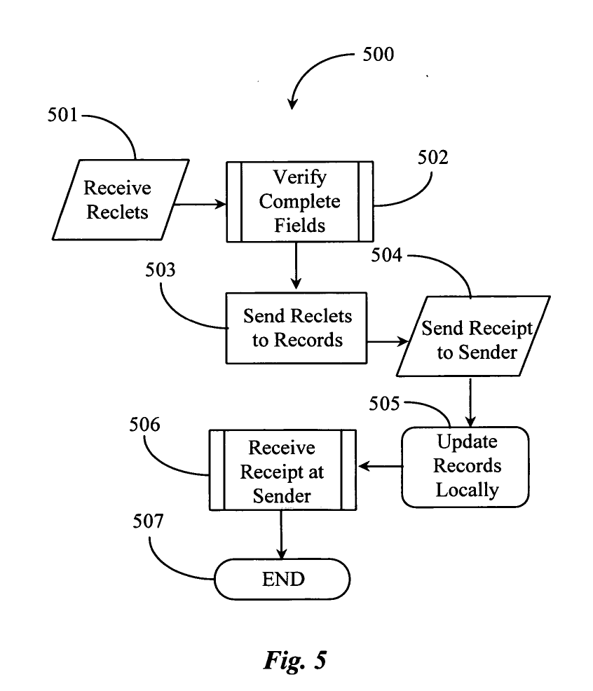

FIG. 5 is a process flow chart 500 illustrating acts for receiving an update for synchronization according to an embodiment of the present invention. This process is a continuation of the process of FIG. 4 wherein the next logical act is receiving one or more reclets at act 501. At act 502 the receiving software CL or API verifies the completeness of information contained in the fields of each reclet received. This act simply determines whether there is enough information for the system to identify the correct record to which the update will apply.

At act 503 each received and validated reclet is sent to its appropriate corresponding record for application to the record. At act 504 an automated receipt is generated and returned to the sender of the record notifying the sender that the record has been received and validated for application. At act 505 the software updates the record locally on the receiving appliance. Back at the transmitting end of the connection, the sending appliance receives one or more receipts for transmitted and validated reclets at act 506. This act corresponds to act 405 described above. At act 507 if no more reclets are transmitted the process ends, generally with the closing of the connection.

One important feature of the present invention is that a record may have a multi-stage history of field changes that are maintained in the record. Assume now for the purpose of discussion that a calendar appointment for a meeting is set for 2 p.m. Now assume that an assistant to the person who set the appointment time changes the appointment time on the server from the original time of 2 p.m. to 1 p.m. It is important to note herein that the actions of the original appointment creator and the assistant have resulted in a record for the calendar item that now contains two revisions for that particular calendar item regarding the start time for the meeting. The original record (created with a start time of 2:00 PM) and the reclet update (time change to 1:00 PM) made at the server or the appliance used to update the server would be propagated to all of the authorized the end users invited to the meeting. There might be 2 synchronization tasks to other devices, one to obtain the new record and the next to receive the update.

In the meantime, before receiving the event through formal data synchronization, a user may receive a telephone call or an email from another potential meeting invitee telling her that the meeting has been set for 1:30 PM (wrong time). Base on that call or email, the user may create a calendar appointment on a smart phone using the wrong time of 1:30. The act of creating the appointment may also create a record for that item that is only stored on her telephone at this point. Now when synchronization occurs to the user's smart telephone, the original record created for the calendar item will be received that reflects the time 2:00 PM (original time) and 1:00 PM (the assistant update).

In this case, there are now 2 records for a same calendar item on the users calendar each having a different source ID number. By default, the software may determine that the oldest record indicating the original source ID of the records creator is the appropriate record for the item. In one case, an alert may be displayed for the user on the smart phone display screen indicating that there are now 2 records for a single event. In this case, the software may associate the two records by comparing field data such as day and time and meeting subject matter or subject line. In one case, the calendar application on the smart phone will simply alert the user to an appointment conflict after receiving the new record. At this point the user may manually review each record and simply delete the record that he or she created using her smart phone realizing that the propagated record with more than one revision is the accurate record for the item. Moreover, if a user tries to create a record for an item that already has a record an alert may be activated informing the user that this item already exists. However, if the user is authorized to create the new record through authentication procedure, then that user may be allowed to make any changes including deleting records thereby deleting the associated items.

In another case, an authorized user may inadvertently provide field data in a reclet update that is incorrect resulting in some inaccuracy. In this case, the record still maintains the previous revisions and source IDs associated to them enabling the user to contact any previous source to determine if indeed the latest revision is valid.

Updated records may cause a display on receiving systems to notify of revisions or changes in order of their establishment history that have been made in a record. The display may be in the form of a popup notification, an alert, or a bubble with text. The notification may be interactive so that the user may determine exactly who initiated changes and when those changes were initiated. In this case, the user may delete her previous item and record realizing she created the record based on faulty information. In the case of documents and editable attachments, the record may enable the user to study the new revision before accepting the changes in a document or replacement of an attachment.

In typical sequence, the user simply editing an item from an initiating station may automatically cause synchronization to an identical document residing on one or more separate stations. Those edits made, for example, in a document will automatically appear in the appropriate fields of the record of the document on the local station. The changed fields then will be packaged as a reclet and transmitted. At the receiving end, those revisions will automatically appear in the version of the document residing on that receiving station thus updating that document. A user may also go back to a preceding version of the document by invoking the record to display the document according to a previous revision according to a previous reclet all the way back to the original document as first received. In this way only the changed data needs to be propagated over the network. Appropriate APIs may be created for various word processing applications, mail clients, graphics editors, computer aided drafting programs, and the like that may incorporate field data into the actual item being changed. In the case of completely deleting and replacing one item with a new item, a more generic record of a folder of items or the like may be maintained. A new item for addition to a folder may be carried as an attachment in a reclet or embedded into a reclet's field. If an item is to be deleted from a folder, then a task field might be populated with a command, the task automatically performed at the receiving end.

There are many applications that might be envisioned for a wide variety of editable media including text editing, audio editing, graphics editing, drawing programs, movie editing, or Web page editing, including any application that employs a combination of those editing functions. These programs resident on editing stations may be enhanced with application program interfaces capable of causing automatic record changes and creation of transmittable reclets through normal editing functions. On the receiving end, a program API may be installed to enhance an editing program to take the changed data from the record and to apply those changes correctly creating an updated version of the changed item.

The methods and apparatus of the present invention may be practiced over any type of network capable of transmitting digital data between systems and nodes including the Internet, an Intranet, a WAN, a LAN, and over wireless links between localized peripherals to a main computing appliance. Available bandwidth used during a data sync operation is conserved because data that the receiving end already has is not retransmitted during an update. Only the data changes need to be transmitted in the appropriate data fields of the reclet. Likewise, peer-to-peer connections require far less handshaking then server-based systems.

In light of the many possible applications described above the present invention should be afforded the broadest interpretation, as the spirit and scope of the present invention should be limited only by the following claims.

What is claimed is:

1. A system for synchronizing data between at least 2 separate appliances connected to a communications network comprising:
one appliance of the at least 2 separate appliances for initiating synchronization;
a data record containing editable and non-editable fields; and
a software program for separating individual ones of editable fields and non-editable fields from the record and packaging them for transmission over the network to one or more of the other appliances.

2. The system of claim 1 wherein the communications network is the Internet network including one or more sub networks connected to the Internet network.

3. The system of claim 1 wherein the communicating appliances are of the same type or any mix of, desktop computers, laptop computers, cellular telephones, personal digital assistants, digital music players, hand held communicators, desktop entertainment systems, mobile information systems, and data servers.

4. The system of claim 1 wherein the appliance initiating a synchronization is one of a desktop computer, a laptop computer, a cellular telephone, a personal digital assistant, a digital music player, a hand held communicator, a desktop entertainment system, or a mobile information system.

5. The system of claim 1 wherein the non-editable fields include one or more fields for identifying the record, a source appliance that originated the record and the source appliance that initiated a revision to the record.

6. The system of claim 5 wherein the editable fields include one or more fields adapted to contain data about an item, pointers to attached data, or command lines for performing one or more tasks related to an item.

7. The system of claim 1 wherein the data record provides at minimum identification data related to the record identification, field identification, source device identification, item revision identification, and status related to a change implementation.

8. The system of claim 7 wherein the data record further identifies the source machine making a data change, the name of the user making the data change, and the name of the user who originally created the record.

9. The system of claim 1 wherein the software program is an application program interface installed to an appliance-resident data processing program.

10. The system of claim 9 wherein the data processing program is one of a word processor, a calendar application, a scheduler, a drawing program, a picture editing application, an email client or a personal data organizer.

11. The system of claim 1 wherein the software program is automatically invoked and automatically completes field replication, packaging, and buffering for transmission based on the user working in a resident client application for editing an item.

12. A data record for facilitating data synchronization comprising:
a plurality of editable and non-editable data fields;
a unique identifier associated with one of the non-editable fields identifying the source of the data record; and
a unique identifier associated with one of the non-editable fields identifying one or more sources who have edited the data record.

13. The data record of claim 12 further including:
an identification of a user that created the record; and
identification of any users who have edited the record.

14. A transmittable synchronization package for synchronizing data between at least two appliances connected to a communication network comprising:
at least one editable data field containing data for synchronization or a pointer to data for synchronization; and
at least one non-editable data field for identifying a record, a source of the synchronization package, and a revision number for the changed data.

15. A software application for facilitating data synchronization between at least 2 appliances connected to a communications network comprising:
a portion thereof for representing an item in the form of a record, the record containing editable and non-editable fields;
a portion thereof for separating individual ones of the editable and non-editable fields from the record into a transmittable update package and for transmitting the package over the network; and
a portion thereof for receiving the transmitted package and applying that package to a version of the original record.

16. The software application of claim 15 further including:
a first application program interface installed to a generic software application adapted to edit the item, the interface adapted to automatically create the transmittable package; and
a second application program interface installed to the generic software application adapted to edit the item, the interface adapted to automatically apply the changed data to the item and to the resident copy of the changed record.

17. The software application of claim 16, wherein the generic application is one of a word processor, a sound editing application, a graphics editing application, a drawing program, an web page editing application, or a movie editing application.

18. A method for synchronizing data between two or more appliances connected to a communications network comprising acts of:
(a) editing an item or performing a task related to an item on a sending appliance;
(b) updating a local record of the item and retaining the change data from the record;
(c) packaging the change data and the record and source identification data for transmission as a record update;
(d) transmitting the package to the other appliance or appliances designated to receive synchronization;
(e) receiving the package at the other appliance or appliances;
(f) updating the local copy of the original record on that appliance or appliances according to the package contents; and
(g) applying the change data from the new record to the item or items to be changed.

19. The method of claim 18 wherein in act (e) a receipt is generated and sent back to the sender after validating the package.

20. The method of claim 18 wherein acts (b) and (c) are automatically performed by an application program interface installed to editing or tasking software adapted to edit or perform tasks related to the item.

21. The method of claim 18 wherein acts (e) through (g) are automatically performed by an application program interface installed to editing or tasking software adapted to edit or perform tasks related to the item, the application program interface invoked at act (e) after the package is sufficiently identified.

22. The method of claim 18, wherein in act (d), the transmission is metered to avoid taxing bandwidth reserved for a higher priority task simultaneously being performed by a sending appliance.
